(19) United States
(12) Patent Application Publication
(10) Pub. No.: US 2003/0105781 A1
(43) Pub. Date: Jun. 5, 2003

(54) Data storage methods and apparatuses with basic and extended file system capacity

(75) Inventor: Octavius J. Morris, Redhill (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/307,696

(22) Filed: Dec. 2, 2002

(30) Foreign Application Priority Data
Dec. 5, 2001 (GB) 0129044.4

(51) Int. Cl. G06F 12/00

(52) U.S. Cl. 707/200

(57) ABSTRACT

Method and apparatus for implementing an extended system of file management on a data storage medium while retaining compatibility with both basic and extended implementations of the file system, the file system providing management information stored on said medium and including at least one management information table containing a number of file information records enabling access to a number of data files stored on said medium. The method comprises distinguishing between basic files, to be accessible in both basic and extended implementations, and extension files, not necessary for a basic implementation, and creating and maintaining said file management table such that records relating to the basic files are stored together in a first part of the table.

The present application relates to data storage apparatus and methods, and in particular to improved file systems for use in such apparatus. The file systems are intended for example for use in digital video recorders (DVRs), but the invention is applicable to data storage apparatus and file systems for other general purpose computing and other specialised applications.

Digital Video Recording is an increasingly important in both the computing and home entertainment fields particularly with the success of DVD (Digital video Disc) players over the past few years. Digital video files need to be managed when stored to disk. There have been designed a number of file systems for this purpose.

Most of the existing file management systems are designed to be used only for computer applications, or are derived from such systems, and therefore lack the functions necessary for AV applications such as real time data reading and writing, or file dividing and combining without data movement. A real-time audio video file system is designed to enable implementation of above and other functions useful for AV application in an effective manner.

Real-time audio video file systems are designed to enable reliable data storage and retrieval, even on a medium that has many defective sectors. High reliability is required especially for data structures that are used for file management. This kind of data is stored in the Management Information Area (MIA).

Such file systems have several different tables in the Management Information Area for storing things like File name, Allocation extents, File attributes etc. In principle these tables can be large. In practice it is normal to keep these basic management tables in memory all the time as they have to be accessed every time a file or part of the file is accessed. Consequently, to reduce the number of slow disc accesses it helps to have the basic addressing information in memory. This information may for example include tables of file information (data and directory file records specifying the sectors where a file is physically stored), file name information (what the files and directories are called) and disk region information (where file information is already stored on the disk and where there is free space). Audio video recorders use a relatively small amount of memory (for costs reasons) and want to use it as efficiently as possible. Therefore the file system specified for such applications will typically impose somewhat arbitrary limits on the size of the management tables, to limit the memory necessary in a basic player/recorder product. To this end, it is envisaged that a basic files system for DVR applications might limit the size of the MIA tables to a few kilobytes each.

The inventor has recognised that these type of restrictions, while being reasonable for early DVR systems, will limit the functionality of such systems very seriously as systems develop in the future. Therefore it is desired to define an extension mechanism for these basic system implementations which maintains read compatibility while allowing for future expansion.

It is an object of the invention to enable the operation of a file system SO as to simplify extension of a basic real-time audio video file system, or general-purpose file system, while maintaining read compatibility and preferably allowing the extension files to have the benefit of being part of the same, single, unified file system.

In a first aspect of the invention there is provided a method for implementing an extended system of file management on a data storage medium while retaining compatibility with both basic and extended implementations of the file system, the file system providing management information stored on said medium and including at least one management information table containing a plurality of file information records enabling access to a number of data files stored on said medium, said method comprising distinguishing between basic files, to be accessible in both basic and extended implementations, and extension files, not necessary for a basic implementation, and creating and maintaining said file management table such that records relating to the basic files are stored together in a first part of the table.

A basic implementation of the file management system can therefore be designed to store all necessary records in a certain memory space, without restricting the capacity of an extended implementation.

Said first part of the table may comprise a first fixed number of records.

The method may further include storing extension file records only outside said first part of the table.

The file management table may comprise a plurality of records linked to one another in a chain, the method being performed so as to link all basic file records in said chain before said extension file records.

The file management table may be one of a plurality of tables, each partitioned to contain only basic file records within a first part of the respective table. In one embodiment, for example, these tables include a file record table, a file name table and a disk region table.

The basic files may comprise digital audio and video recordings and auxiliary data for use in relation thereto, while the extension files comprise other computer data.

The invention in a second, related, aspect provides a method for implementing a basic system of file management on a data storage medium while retaining compatibility with both basic and extended implementations of the file system, the file system providing management information stored on said medium and including at least one management information table containing a plurality of file information records enabling access to a number of data files stored on said medium, said files including basic files, to be accessible in the basic implementations, and extension files, not necessary for the basic implementation, said file management table being created and maintained such that records relating to the basic files are stored together in a first part of the table.

The method may include performing file storage and retrieval operations while retaining in working memory only said first part of the Pr each management information table.

The basic implementation of the file management system may include processing specifically to support the extended implementation, while avoiding storage of the entire management information in working memory.

For example, the method may further comprise as a preliminary step reading and processing at least some management information relating to said extension files, to determine free space available on said storage medium for new basic files.

The method may further comprise a step of merging the retained part of the or each management information table with at least a part of the table relating to extension files when re-writing the management information table to the storage medium.

Said first part of the table may comprise a first fixed number of records.

The method may further include storing extension file records only outside said first part of the table.

The file management table may comprise a plurality of records linked to one another in a chain, the method being performed so as to link all basic file records in said chain before said extension file records.

The file management table may be one of a plurality of tables, each structured to contain only basic file records within a first part of the respective table. In one embodiment, for example, these tables include a file record table, a file name table and a disk region table.

The basic files may comprise digital audio and video recordings and auxiliary data for use in relation thereto, while the extension files comprise other computer data.

The invention in a third aspect provides a data storage medium wherein there are stored basic data files and extension files and file management information suitable for implementing a file system to access the files in a structured manner, the file management information including at least one management information table containing a plurality of file information records enabling access to said files, the basic files to be accessible in both basic and extended implementations of the file system while the extension files are not necessary accessible for the basic implementation, wherein said file management table is structured such that records relating to the basic files are stored together in a first part of the table.

Said first part of the table may comprise a first fixed number of records.

The extension file records are preferably stored only outside said first part of the table.

The file management table may comprise a plurality of records linked to one another in a chain, the links being such as to link all basic file records in said chain before said extension file records.

The file management table may be one of a plurality of tables, each structured to contain only basic file records within a first part of the respective table. In one embodiment, for example, these tables include a file record table, a file name table and a disk region table.

The basic files may comprise digital audio and recordings and auxiliary data for use in relation thereto, while the extension files comprise other computer data.

In a fourth aspect of the invention there is provided a data storage apparatus comprising an interface to a removable data storage medium and control means arranged to implement an extended system of file management on the data storage medium by a method according to the first aspect of the invention as set forth above.

In a fifth aspect of the invention there is provided a data storage apparatus comprising an interface to a removable data storage medium and control means arranged to implement a basic system of file management on the data storage medium by a method according to the second aspect of the invention as set forth above.

Either apparatus may comprise a domestic digital video recorder

Embodiments of the invention will now be described, by way of example only, by reference to the accompanying drawings, in which:

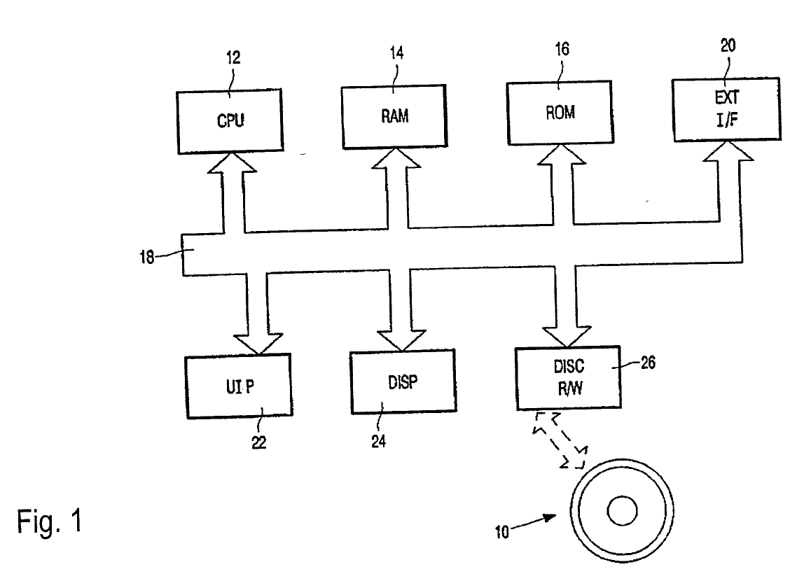

FIG. 1 is a block schematic diagram of a data processing apparatus which may be configured to implement a basic or extended file system in accordance with the present invention;

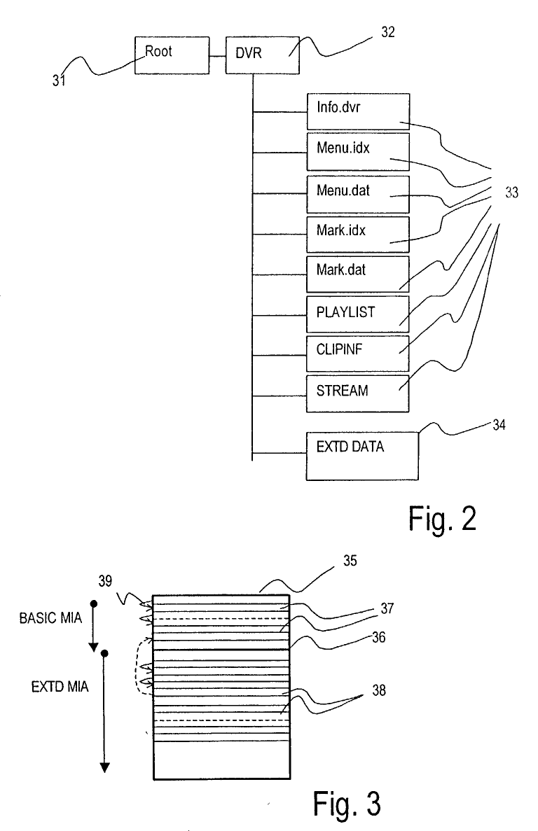

FIG. 2 shows a file directory structure for a DVR incorporating extension files; and

FIG. 3 shows a file table that has been partitioned in accordance with the method of the invention.

FIG. 1 shows the basic components of a data processing apparatus such as may be used for the formatting and storing of data on an optical disc 10. The apparatus consists of a central processor (CPU) 12 coupled in a conventional manner with random-access memory (RAM) 14 and read-only memory (ROM) 16 via an address and data bus 18. An external interface (EXT I/F) 20 represents the apparatus connection with external data sources. As will be recognised, the configuration of this interface will be dependent on the type of external data sources and the overall function of the data processing apparatus. Using (for the sake of example only) a domestic video/audio recorder, the interface will provide the connection and reception means for the source of video and audio signals to be recorded (such as from a satellite receiver). Where the apparatus is a personal computer or email device, as another example, it may comprise a link to remote data sources by way or, for example, and internet interface.

Also coupled with CPU 12, memories 14, 16 and interface 20 via the bus 18 are one or more user input means (UIP) 22 and a display 24. For a PC-based apparatus, these devices may comprise respectively a keyboard and monitor. For a domestic A/V recorder apparatus they may comprise user control buttons and an LED or like display on the apparatus front panel. A further component is an interface to a storage medium, in this example an optical disc recording and playback unit (DISC R/W) 26. Unit 26 provides both the physical means to load and read and write data from and to the disc 10 and an internal set of operational protocols for reading & writing data formatted according to a predetermined standard. As will be well understood, the protocol handling of unit 26 may be effected by an internal slave processor with associated memory (not shown) with only higher-level control implemented by CPU 12, or these functions may be handled directly by CPU 12 with reference to programs held in ROM 16 and executed from there, or periodically reloaded to RAM 14. The basic construction and operation of such apparatuses are well-known to those skilled in the art and need not be described here for an understanding of the present invention. The remainder of this description concerns the file management system for the data storage apparatus, with particular reference to a DVR application, and with particular reference to features of the system providing for a basic and extended capacity file system within a simple and integrated data structure.

In general file systems are “mounted” on a “logical volume” to be accessed by application programs running on CPU 12. The present file system assumes a fixed volume structure on the whole DVR medium (disc 10). As is common, every file or directory belongs to a directory. Also every file and directory on a logical volume belongs to a single “tree” of files and directories which starts from a special directory called a root directory. This structure is called a directory hierarchy. A file or a directory is identified by a file name within the directory it belongs to. Any file or directory on a logical volume can be identified by the path of directories started from the root directory and the file name of the object.

FIG. 2 shows an example directory structure suitable for storing DVR information on disc 10 of FIG. 1. This directory tree includes a root directory 31, a DVR directory 32, and inside the DVR directory, examples 33 of DVR files (“info.dvr” etc.) and sub-directories (PLAYLIST etc.). Outside the basic DVR application directory structure are the extension files and directories 34.

The present real-time audio video file system defines a number of management information tables stored in management information area (MIA) to support various file system functions; for example these tables might include a map of the MIA, a file table, a file name table and/or a disk region table. The MIA information can be found directly or indirectly via pointers stored as part of a file system description at a set location on the disc. The MIA may be stored in a robust fashion, for example being duplicated at separate locations on the disc surface. To implement the desired functions, the MIA is generally to be read in its entirety into RAM 14. Accordingly the size of the MIA has a direct impact on the memory capacity and hence the cost of the apparatus as a whole.

The following tables are included as part of the MIA in the present example, although different structures for the MIA are of course possible. All tables are made of fixed-length records so that each record can be looked up quickly by record number. Firstly a file table includes data file records and directory records. A file is an entity that keeps file data and attributes. It is described by the data file record. A directory is an entity that refers to zero or more files and/or directories. It is described by the directory file record. A directory does not hold data but it does have attributes The file table is made up of a file table header and a number of file records, linked into a chain by pointers. Table 1 below shows the various fields within a generic file record format. The attributes of a file or directory are stored in the corresponding file record, or in the extended attribute record referred to by the file record. The file record contains the first file-name record number of the chain. File name records are stored in a separate file name table. A name of a file or directory is stored in a file name record chain, to allow for file names longer than a single file name table record.

TABLE 1
File Table Record Format

File Name
Next Link
Parent Link
Attribute
Extended Attribute Record Number
File Record Type
File Record Type Dependent Field
Creation Time
Modification time

The File Name field specifies the File Name Record Chain, stored separately in a File Name table, which contains a sequence of bytes to identify the file or the directory, referenced by this File Record within the directory.

Next Link specifies a file or a directory that belongs to the same directory. The File Record number of the file or the directory is set in this field. If this File Record is the last entry of the linked list, a special value is set in this field.

Parent Link specifies the File Record number of the directory to which the file or the directory belongs.

Attribute specifies the attribute of either this File Record, or the file or the directory specified by this File Record.

Extended Attribute Record Number specifies an optional Extended Attribute Record Chain used to store the extended attributes of either this File Record, or the file or the directory specified by this File Record.

File Record Type specifies a value that designates the type of File Record such as whether it is a free file record (indicating a file is not in use), a directory file record (used to describe a directory) or a data file record (used to describe a file). Other field names are self-explanatory.

Separately within the MIA, a Disc Region Table stores file data as the contents of an ordered sequence of disc region records. The disc region records are numbered with consecutive integers assigned in an ascending sequence. The number is referred to as disc region record number. A linked list of disc region records is made by setting the next record's disc region record number in the next disc region record field, and is referred to as disc region record chain. A disk region table consists of a disk region header and one or more disc region records. Table 2 below shows the fields within one Disc Region Record.

TABLE 2
Disc Region Table Record Format

Start Logical Block Number
End Logical Block Number
Start Offset
End Offset
Next Region Disc record

Start Logical Block Number specifies the logical block on the disc 10 that includes the start byte of the Disc Region. Each block contains a fixed number of disc storage sectors.

End Logical Block Number specifies the logical block that includes the end byte of the Disc Region.

Start Offset specifies offset of the start byte of the Disc Region from the beginning of the logical block that contains it.

End Offset specifies offset of the end byte of the Disc Region from the beginning of the logical block that contains it.

Next Disc Region Record points to the next Disc Region Record on a Disc Region Record Chain. A special value indicates that this Disc Region Record is not in use and may be used to describe a new Disc Region. Another special value specifies that this is the last entry of the chain.

FIG. 3 illustrates how each of the MIA tables can include information for a “basic” file system, and also the extended directories and files 34 (FIG. 1) without increasing the minimum “memory footprint” of the file system within the RAM 14. FIG. 3 shows MIA table 35, which represents each of the file table, file name table and disc region table. All apparatuses, whether they only basic or extended file system capability, follow a rule whereby records 37 up to a certain limit 36 (e.g. 4K records) are exclusively used to describe and manage the basic files and directories 33, while records 38 above this limit are used to describe and manage the extension files 34. This greatly simplifies both the filtering and merging operations and ensures that the same MIA and management information tables and software are used for managing both the basic files and the extension files.

The number of records defined as the limit for the basic file system may be different for each type of table. For example, in a preferred embodiment, the file table, file name table and disk region table are restricted to 4 k, 4 k and 8 k respectively. The area outside these limits can then be used to store records relating to non-DVR files such as computer application files, which may be stored on the same disk. In order to expand on the limits imposed on such a file system, DVR files beyond these arbitrary limits should only be allowed in directories not defined or used by the basic DVR implementation. These directories contain the extension files 34.

In the a basic implementation of a real-time audio video recording apparatus of FIG. 1, it is only necessary to have the MIA for the 4 k or other maximum number of files that are required for a particular implementation. Additional files, file names and disc regions that are referenced by other files (such as extension files) can be ignored in such a basic implementation. Of course the allocation of space for these extension files must be respected and not overwritten by this basic implementation.

In order to ensure that this does not happen, the basic apparatus in this embodiment in fact reads the entire extension file management tables from the disk, makes a free space map, and identifies (filters) which of the files are not relevant to the basic implementation. The freespace map can be built by reading the whole file table; for each file in the file table and finding the set of disc regions in the disc region table that it uses; hence deriving the parts of the disc that have already been used; and from that the parts of the disc that are free to be used.

Alternatively and perhaps easier (though more error prone for not-quite compliant implementations), the disc region table can be read and the Next Disc Region Record field examined. If this field is 0 the record is unused, otherwise it is used.

The entries in the tables for the “non-relevant files” in the file table and disc region table need not be kept in memory after they have been loaded. The file tables are filtered by the basic implementation).

After the file tables have been updated, for example as part of a new video recording operation, the modified file tables and disk region tables etc. must be written to the disc 10. For this purpose, in the basic apparatus, the basic file tables 37 are merged with the extension information 38 in each table by reading the extension information temporarily from the disc 10. The merging of the updated basic tables with the extension tables on disk is done by partitioning the file table, the file name table and the disc region table. such that the bottom 4 k stored in memory is concatenated with the higher entries left on the disc. The complete structures are then written back to disk. This processing is an extra burden on the basic apparatus, but is possible within the same memory footprint as a straightforward basic implementation, and has the benefit of providing compatibility with an extended apparatus having a large memory capacity, sufficient to store the entire MIA table 35.

Where the apparatus of FIG. 1 has sufficient memory to implement the extended file system, the entire MIA tables can be read into memory, and the above filtering and merging steps can be omitted. To maintain compatibility of the disc 10 with basic apparatuses, however, DVR file information is always stored within the basic area 37 of the relevant MIA tables 35, while records relating to non-DVR files 34 are stored in the extension records 38. Where the table 35 comprises a linked list or “chain”, as in the examples given, the apparatus ensures that all basic records 37 are linked together in the chain, before any of the extension records 38. That is to say, all of the basic records 37 can be identified by following links 39 etc. entirely within the basic part of the table 35 below limit 36, and links such as those shown dotted in FIG. 3 are not permitted.

As an example, the following steps may be implemented in the apparatus for, firstly, reading and secondly, writing a file in the basic area, where the file table and disk region table for basic data are limited at 4 k entries and 8 k entries respectively:

To read a file:

Mount volume

Read file table (<4 k)

Read disk region table (<8 k)

Identify required file in file table

From file record find first disk region record

Follow chain of disk region records

From disk region records find addresses on disk of required data

Read required data

To write a file:

Mount volume

Read file table (<4 k)

Read entire disc region table

From the disc region table, construct a map of free space on the disc

The higher portion of the DRT in memory can be discarded

Find a spare slot in the first 4 k of the file table

Record the data onto the disc in free space according to the free space map

During recording construct disc regions in the disc region table “pointing to” the locations of the recorded data. Disc regions are in the lower 8 k portion of this table

At the end of the recording, read and update the basic portions of both the FT and DRT.

It will be appreciated that the file system described herein satisfies the aims of the invention as set forth in the introduction. It may be noted that the file system from its inception accommodates basic and extended models of apparatus. Rather than providing a second file system invisible to the basic apparatus, by using an entirely separate MIA, or separate partitions, the basic apparatus in this system is to some extent aware of the extended data. The structures and rules adopted simply allow basic and extended apparatus to share the same file system, while allowing the basic apparatus to accommodate the entire relevant MIA within a known, small memory capacity.

It will be appreciated that a succession of limits 36 etc can be defined, allowing different levels of extended apparatus to operate, each within a known memory footprint. This and other variations of the examples described will be recognised by the skilled person, while remaining within the spirit and scope of the invention defined by the appended claims.

1. A method for implementing an extended system of file management on a data storage medium while retaining compatibility with both basic and extended implementations of the file system, the file system providing management information stored on said medium and including at least one management information table containing a plurality of file information records enabling access to a number of data files stored on said medium, said method comprising distinguishing between basic files, to be accessible in both basic and extended implementations, and extension files, not necessary for a basic implementation, and creating and maintaining said file management table such that records relating to the basic files are stored together in a first part of the table.

2. The method according to claim 1 wherein said first part of the table comprises a first fixed number of records.

3. The method according to claim 1 wherein said method further includes storing extension file records only outside said first part of the table.

4. The method according to claim 1 wherein the file management table comprises a plurality of records linked to one another in a chain, the method being performed so as to link all basic file records in said chain before said extension file records.

5. The method according to claim 1 wherein the file management table is one of a plurality of tables, each partitioned to contain only basic file records within a first part of the respective table.

6. The method according to claim 5 wherein said tables include a file record table, a file name table and a disk region table.

7. The method according to claim 1 wherein the basic files comprise digital audio and video recordings and auxiliary data for use in relation thereto, while the extension files comprise other computer data.

8. A method for implementing a basic system of file management on a data storage medium while retaining compatibility with both basic and extended implementations of the file system, the file system providing management information stored on said medium and including at least one management information table containing a plurality of file information records enabling access to a number of data files stored on said medium, said files including basic files, to be accessible in the basic implementations, and extension files, not necessary for the basic implementation, said file management table being created and maintained such that records relating to the basic files are stored together in a first part of the table.

9. The method according to claim 8 wherein said method includes performing file storage and retrieval operations while retaining in working memory only said first part of the or each management information table.

10. The method according to claim 9 wherein the basic implementation of the file management system includes processing specifically to support the extended implementation, while avoiding storage of the entire management information in working memory.

11. The method as claimed in claim 10 wherein said method further comprises as a preliminary step reading and processing at least some management information relating to said extension files, to determine free space available on said storage medium for new basic files.

12. The method according to claim 8 wherein said method further comprises a step of merging the retained part of the or each management information table with at least a part of the table relating to extension files when re-writing the management information table to the storage medium.

13. The method according to claim 8 wherein said first part of the table comprises a first fixed number of records.

14. the method according to claim 8 wherein the method further includes storing extension file records only outside said first part of the table.

15. The method according to claim 8 wherein said file management table comprises a plurality of records linked to one another in a chain, the method being performed so as to link all basic file records in said chain before said extension file records.

16. The method according to claim 8 wherein the file management table are one of a plurality of tables, each structured to contain only basic file records within a first part of the respective table.

17. The method according to claim 16 wherein said tables include a file record table, a file name table and a disk region table.

18. The method according to claim 8 wherein the basic files comprise digital audio and video recordings and auxiliary data for use in relation thereto, while the extension files comprise other computer data.

19. Data storage medium wherein there are stored basic data files and extension files and file management information suitable for implementing a file system to access the files in a structured manner, the file management information including at least one management information table containing a plurality of file information records enabling access to said files, the basic files to be accessible in both basic and extended implementations of the file system while the extension files are not necessary accessible for the basic implementation, wherein said file management table is structured such that records relating to the basic files are stored together in a first part of the table.

20. The medium of claim 19 wherein said first part of the table comprises a first fixed number of records.

21. The medium according to claim 19 wherein the extension file records are stored only outside said first part of the table.

22. The medium according to claim 19 wherein the file management table comprises a plurality of records linked to one another in a chain, the links being such as to link all basic file records in said chain before said extension file records.

23. The medium according to claim 19 wherein the file management table is one of a plurality of tables, each structured to contain only basic file records within a first part of the respective table.

24. The medium according to claim 23 wherein said tables include a file record table, a file name table and a disk region table.

25. The medium according to claim 19 wherein the basic files comprise digital audio and recordings and auxiliary data for use in relation thereto, while the extension files comprise other computer data.

26. Data storage apparatus comprising an interface to a removable data storage medium and control means arranged to implement an extended system of file management on the data storage medium by a method according to claim 1 above.

27. The apparatus as claimed in claim 26 wherein said apparatus comprises a domestic digital video recorder.

28. Data storage apparatus comprising an interface to a removable data storage medium and control means arranged to implement a basic system of file management on the data storage medium by a method according to claim 8 above.

29. The apparatus as claimed in claim 28 wherein said apparatus comprises a domestic digital video recorder.
